(19) United States
(12) Patent Application Publication
(10) Pub. No.: US 2019/0011133 A1
(43) Pub. Date: Jan. 10, 2019

(54) A TRAY FOR AN OVEN, COMPRISING EXTENSIONS

(71) Applicant: ARCELIK ANONIM SIRKETI, Istanbul (TR)

(72) Inventors: Arda KUYUMCU, Istanbul (TR); Sena DAVASLIGIL, Istanbul (TR); Haluk KARATAS, Istanbul (TR); Merve GUVEN, Istanbul (TR); Asli Saime KAYIHAN, Istanbul (TR)

(21) Appl. No.: 16/065,944

(22) PCT Filed: Nov. 30, 2016
(86) PCT No.: PCT/EP2016/079278

§ 371 Date: Jun. 25, 2018

(30) Foreign Application Priority Data
Dec. 29, 2015 (TR) 2015/17339

(51) Int. Cl. F24C 15/16; A21B 3/15

(52) U.S. Cl. CPC F24C 15/16; A21B 3/15

(57) ABSTRACT

The present invention relates to a tray which is suitable to be used in an oven comprising a base and more than one extension that is placed on the base in an inclined manner and that enables the foodstuffs to be placed therebetween. Said tray enables the fresh foods to be dried.

The present invention relates to a tray suitable for use in ovens.

Today ovens are used for meeting the needs such as preparation, heating, cooking, etc. of foodstuffs. The ovens exhibit structural and design differences depending on the need and can be used in a broad field. The basic oven structure consists of a chamber wherein foodstuffs are placed and of a heater. Inside the chamber, trays that provide the positioning of the foodstuff according to the desired cooking method and that can be easily removed from the chamber when desired, providing convenience of use are used.

Depending on the need for use, types of heater inside the oven and the chamber structures may vary. The heaters direct the heat from reactions such as electricity, gas, electromagnetic waves, etc. through the transmission channels to the chamber. The positioning of the foodstuffs so as to be exposed to heat in a most efficient manner according to the position of the said transmission channels is often provided by means of trays. The trays assist in the most effective heat transfer depending on the cooking need by being slid on the grooves with varying levels inside the chamber.

In ovens designed for use for a special purpose, the tray structure is also changed. In ovens designed for drying fresh foods such as vegetables, fruits, etc., it is aimed to evaporate the juice contained in the food. To this end, an area as wide as possible must be directly exposed to heat. In order to balance the resulting thermal process dynamics, extra energy requirement occurs. Economic productivity is provided by means of high capacity, while its application in the household appliances creates difficulty.

In the state of the art, trays produced from wooden laths or stainless steel wire are used in the ovens suitable for drying foods.

In the state of the art United States of America Patent Document No. US20090126221, a tray suitable for use in drying ovens is disclosed.

The aim of the present invention is the realization of a tray that enables the foodstuffs to be dried in the domestic ovens.

The tray realized in order to attain the aim of the present invention, explicated in the first claim and the respective claims thereof, is designed so as to be used in an oven when desired. Extensions are provided at the base of the tray, extending upward from the upper surface of the tray. The said extensions are positioned at certain intervals on the surface of the base and serve as support to foodstuffs placed on the tray, enabling the foodstuffs to be kept at the desired position. This feature is suitable for drying especially fresh vegetables and fruits. In order to dry fresh foods, the juice contained by fresh foods is required to be removed from the medium rapidly by means of thermal process. In order to enlarge the surface area of the foodstuffs and reduce the amount of juice per unit area, the foodstuffs must be exposed to drying process by being thinly sliced. Another critical issue here is that as the heat evaporates the juice in the foodstuff, the foodstuff must not spoil due to roasting. Therefore, minimum contact of the foodstuff with the hot surface inside the oven is provided and the heat is enabled to be distributed over all the surfaces of the foodstuff and to be rapidly dehydrated by discharging the water vapor from all the surfaces.

In an embodiment of the present invention, the base is of perforated structure. The perforated structure continues along the entire surface of the base. Thus, the heat transfer to the base is reduced and the heat is enabled to be directly delivered to the foodstuff, providing a more regular heat distribution inside the oven. The perforated structure can be implemented in the form of a cage. By means of this embodiment, as the weight of the tray is reduced as well, ease of use and saving from material are provided.

In another embodiment of the present invention, the extensions are formed perpendicular to the base. By increasing the number of the extensions and uniformly placing the same across the entire base, a large number of materials are supported. This embodiment provides homogenous heat transfer by slicing fruits and vegetables in thin slices and placing the same in an upright manner on the tray. Moreover, when the materials are placed in an upright manner, the material carrying capacity of the tray is increased.

In an embodiment of the present invention, the extension is in the form of a single-piece plate extending along the length of the tray. Large size and thin foodstuffs are enabled to be supported and it becomes easy to arrange the foodstuffs on the tray. The plate-shaped extension can extend uninterruptedly along the edge of the tray or can be used in the form of interrupted sections along the edge or along a certain part only.

In an embodiment of the present invention, the extensions can be folded. The plate-shaped extensions can be folded and laid down on the base of the tray. When laid down on the base, the plates are positioned so as to be in alignment without overlapping each other. When the plate is not used and is stored as folded up, minimum space is occupied for the storage thereof.

In an embodiment of the present invention, the extension comprises at least one housing. The extension is produced so as to be detached from the base. The extension is fixed to the joint on the base by means of a pin that is suitable to be fitted into the housing on the extension. The joint can be produced together with the base or can be mounted on the base subsequently. The extension is mounted so as to rotate around the pin. Thus, the extension can be removed when not used or can be closed by being laid down on the base.

In an embodiment of the present invention, the rotatably mounted extension can be fixed in various positions by means of a locking mechanism so as to make different angles with the base. The extension can be fixed in an inclined or upright manner depending on the type and size of the foodstuff to be supported. The extension can be partially or completely brought to the closed position depending on the required use capacity. The movable extensions can be fixed in the desired position against the risk of moving due to the weight of the foodstuffs. Moreover, when the extension is wanted to be stored in the closed position, the extension can be fixed in this position and stored safely independently of the transport or storage position. The locking mechanism can be provided by fitting a recess or channel on the extension and a flexible protrusion on the joint or the base into each other. Thus, by means of the pressing force applied by the user, the component stretches and fits into place, thus providing fixing, and similarly, the component can be released from its position by means of the pressing force. Basically, fixing is provided in the first position that provides the upright positioning of the extension, in the second position that provides the inclined (at an angle of 45 to 70 degrees) positioning, and in the third position wherein the extension is laid down, near-parallel with the base, on the surface of the base.

In another embodiment of the present invention, window-shaped openings are provided on the extension. Existence of the said opening becomes critically important as the length of the extension increases. There can be one or more than one opening on an extension. The opening can be in the form of a cut-out on the plate as well as in the form of a cage or a wire construction. By means of the opening, the contact of the support with the foodstuff is reduced and the heat passing through the opening is enabled to be homogenously delivered to the foodstuff. Moreover, lesser material is used in the production of the extension and the weight of the tray decreases.

In another embodiment of the present invention, the extensions are positioned both on the lower surface and the top surface of the base. Preferably, the extensions are provided on one surface in the form of fixed short upright members and broader and longer foldable extensions so as to hold larger materials are provided on the other surface. Depending on the need for use, the tray is placed inside the oven so that the required surface is on the top. Thus, the tray can meet more alternative use options. The extensions that can be folded when it is not necessary to place large materials are laid down on the base and locked. Thus, the extensions are prevented from occupying unnecessary space inside the oven.

In another embodiment of the present invention, handles are provided on the two opposite edges of the tray. The handles serve as rails by means of which the tray can be slid inside the carriage channels formed on the side walls of the oven and positioned in the placement of the tray inside the oven. The handles can extend along the edge of the tray as well as can be formed in any section of the edge. The handles can be positioned either at the same level or at different levels with the base of the tray. Moreover, the handles function as handle for the purpose of providing comfortable use in the handling of the tray.

In another embodiment of the present invention, the tray is used in a microwave oven. The tray material is produced from a material which is resistant to microwave radiations and suitable for transmission of radiations without refraction. Since the microwave ovens provide heating by setting the molecules of the juice contained in the food into motion, the trays provide more efficient use in the drying of foodstuff by evaporating the juice.

By means of the present invention, a tray that enables drying of fresh foods at home and that is suitable for use inside the oven, is realized.

The tray realized in order to attain the aim of the present invention is illustrated in the attached figures, where:

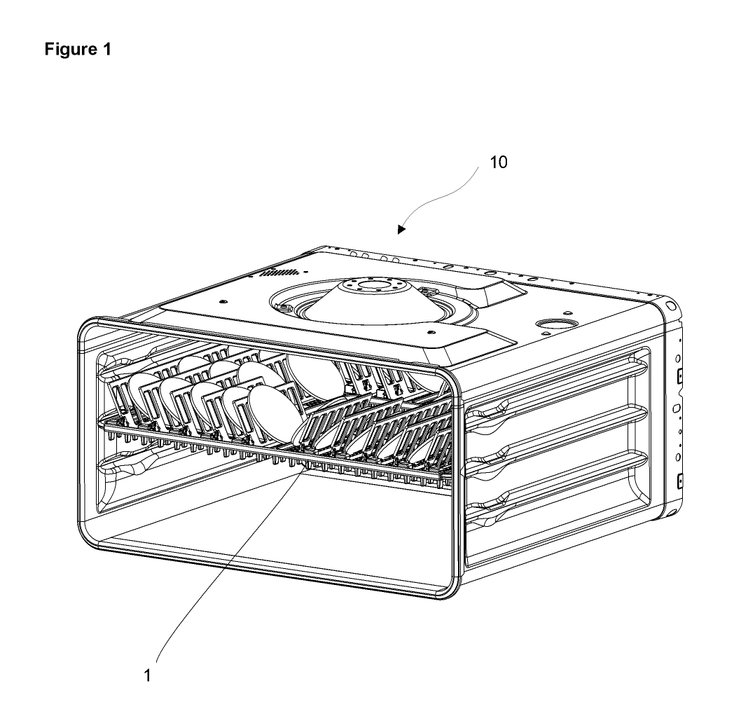

FIG. 1—is the perspective view of the tray positioned inside the oven.

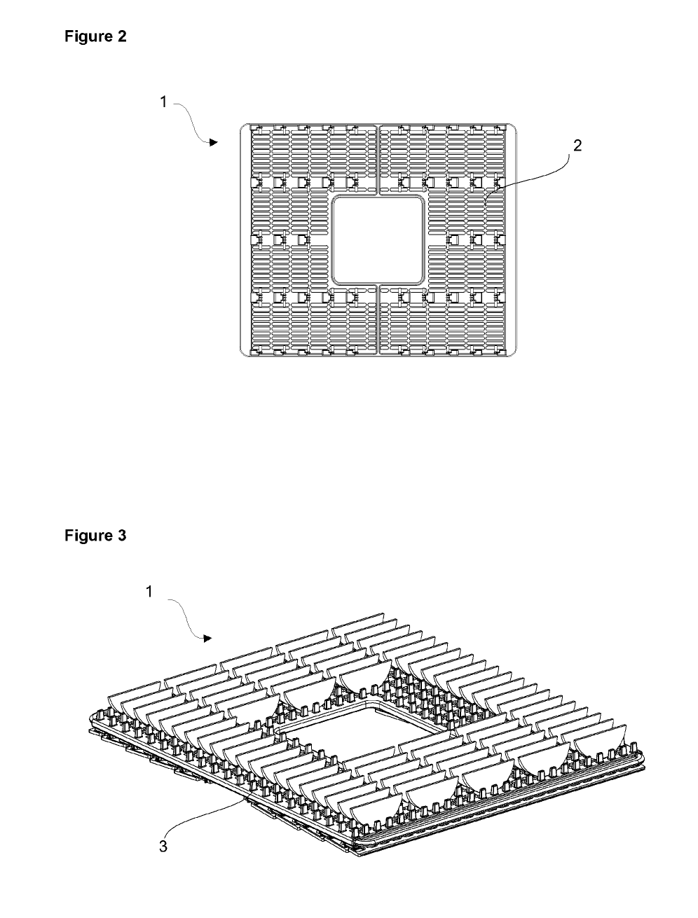

FIG. 2—is the top view of the tray in an embodiment of the present invention.

FIG. 3—is the perspective view of the tray in an embodiment of the present invention.

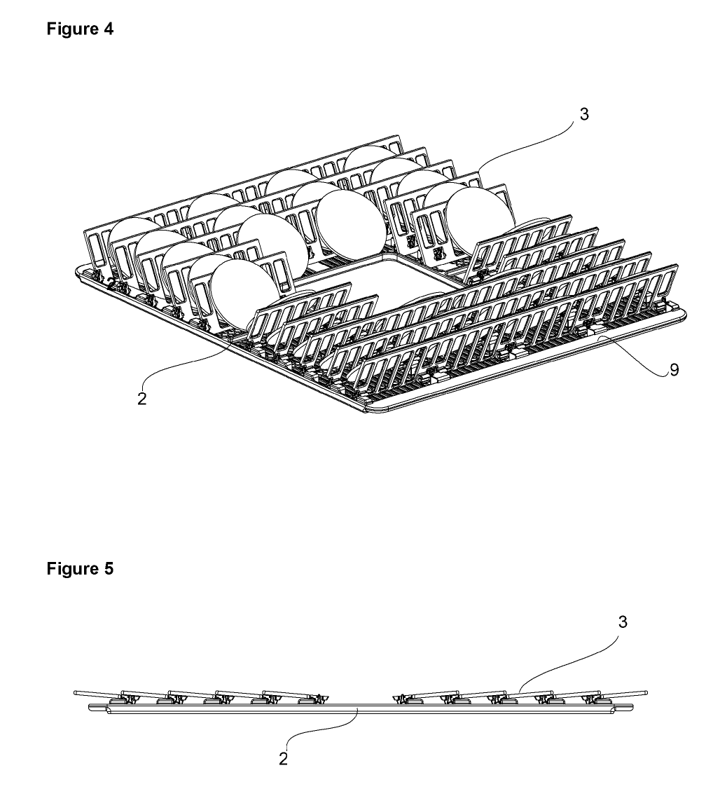

FIG. 4—is the perspective view of the tray in another embodiment of the present invention.

FIG. 5—is the sideways view of the tray in an embodiment of the present invention.

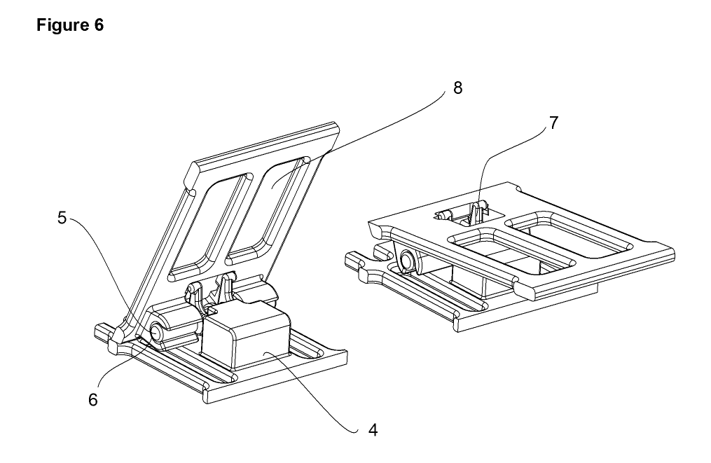

FIG. 6—is the perspective view of the extension and the connection elements.

The elements in the figures are numbered as follows:
1. Tray
2. Base
3. Extension
4. Joint
5. Pin
6. Housing
7. Locking mechanism
8. Opening
9. Handle
10. Microwave oven

The tray (1) of the present invention is suitable for use inside an oven and comprises a base (2) and more than one extension (3) that is placed on the base (2) in an angular manner and that allows the placement of foodstuffs therebetween. The extensions (3) extend from the surface outward as integrated with the surface of the base (2). The extensions (3) function as support for the positioning of the foodstuffs placed on the tray (1). By means of frequent placement of the extensions (3) across the area of the base (2), more foodstuff can be placed thereon (FIG. 1).

In an embodiment of the present invention, the tray (1) comprises a base (2) of perforated construction. By means of the perforated construction, when the tray (1) is used inside the oven, homogenous distribution of the heat inside the oven is provided. The holes can be formed by means of wires joined together in the form of a cage or by using wooden laths one after another. By means of the perforated base (2) a lighter tray (1) is produced. Thus, convenience of use is provided (FIG. 2).

In an embodiment of the present invention, the tray (1) comprises the extensions (3) perpendicular to the base (2). By means of the positioning of the extensions (3) perpendicular to the base (2), it becomes possible to place the foodstuffs on the tray (1) in an upright manner and thus more foodstuffs can be placed on the same area. When the fresh foods such as vegetables and fruits are desired to be dried, surface areas of these materials can be expanded and their unit juice amounts can be decreased. Therefore, by thin slicing such foodstuffs, maximum heat transfer surface is created and the juice the foodstuffs contain is evaporated. When such foodstuffs are positioned on the tray (1) in an upright manner, minimum contact with the tray (1) is provided and homogenous heat transfer from a surface as wide as possible is ensured. The upright extensions (3) are efficiently used preferably for the placement of small piece foodstuffs (FIG. 3).

In another embodiment of the present invention, the tray (1) comprises the one-piece extension (3) extending along the length of the tray (1). By means of the extensions (3) extending along the line, support is provided for the positioning of large piece foodstuffs (FIG. 4).

In an embodiment of the present invention, the tray (1) comprises the foldable extension (3). The extension (3) is rotated to be laid down near-parallel to the surface of the base (2). If there is more than one extension (3), the distance between the extensions (3) is arranged such that when laid down, the extensions (3) do not overlap each other. To this end, the extensions (3) are arranged in alignment (FIG. 5).

In an embodiment of the present invention, the tray (1) comprises a joint (4) disposed on the base (2), a pin (5) disposed on the joint (4), and an extension (3) having at least one housing (6) suitable for receiving the pin (5). The joint (4) is produced as integrated with the base (2) and is seated into the housing (6) on the body of the extension (3) by means of a pin (5) passing therethrough, thus enabling the extension (3) to be rotatably connected to the base (2). Thus, the extension (3) is laid down on the base (2) when not in use and is prevented from occupying unnecessary space (FIG. 6).

In this embodiment of the present invention, the tray (1) comprises a locking mechanism (7) that enables the extension (3) to be fixed to the base (2) so as to make different angles with the base (2). By means of the pin (5) being seated into the housing (6), the extension (3) can be positioned on the base (2) in an inclined manner. There are recesses formed oppositely at different levels on the extension (3) in order to fix the extension (3) at these positions as required. Corresponding to these recesses, opposite protrusions are provided on the joint (4). These elements are preferably produced from flexible material. By stretching and seating the protrusions into the differently aligned recesses, fixing in different positions is provided.

In another embodiment of the present invention, the tray (1) comprises the extension (3) whereon a window-shaped opening (8) is arranged. When the foodstuffs are rested against the extension (3), they are exposed to heat transfer from this section as well by means of the opening (8), thus increasing the efficient evaporation surface. The opening (8) can be formed by creating a cut-out on the extension (3) or by arranging wire-formed materials in the form of a matrix.

In another embodiment of the present invention, the tray (1) comprises the extensions (3) disposed on both lower surface and top surface of the base (2). The extensions (3) have different characteristics with respect to two surfaces. One surface comprises the extension (3) in the form of a short upright member which is suitable for the placement of a large number of small-sized foodstuffs, while the other surface comprises the long extension (3) which can be folded for convenience of storage, whereon large and thin materials are placed. The tray (1) is positioned with the desired surface on top when used inside the oven (FIG. 3, FIG. 5).

In another embodiment of the present invention, handles (9) extending on both sides of the tray (1) are provided. The handle (9) can either extend along the length of the edge or be disposed on a certain section. The handle (9) protrudes outward from the base of the tray (1) and the section outside forms the handle (9). The handle (9) has a form suitable for moving inside the channels suitable for the tray (1) placement inside the oven (FIG. 4).

In another embodiment of the present invention, the tray (1) is suitable to be used inside a microwave oven (10). Thus, by producing the tray (1) from a material which does not reflect the microwave radiations, homogenous transmission of the radiation is not prevented (FIG. 1).

By means of the present invention, a tray (1) is realized, that is suitable to be used inside the oven and that enables the foodstuffs to be efficiently dried by providing the placement of foodstuffs in different positions on the base (2).

1. A tray suitable to be used in an oven, comprising a base, characterized by more than one extension that is placed on the base in an inclined manner and that enables the foodstuffs to be placed therebetween.

2. The tray as in claim 1, characterized by the base of perforated construction.

3. The tray as in claim 1, characterized by the extension perpendicular to the base.

4. The tray as in claim 1, characterized j the one-piece extension extending along the length of the tray.

5. The tray as in claim 1, characterized by the foldable extension.

6. The tray as in claim 5, characterized by the extension comprising a joint disposed on the base, a pin disposed on the joint and at least one housing suitable for receiving the pin.

7. The tray as in claim 5, characterized by a locking mechanism that enables the extension to be fixed onto the base so as to make different angles with the base.

8. The tray as in claim 1, characterized by the extension having a window-shaped opening thereon.

9. The tray as in claim 1, characterized by the extensions disposed on both the upper surface and lower surface of the base.

10. The tray as in claim 1, characterized by the handles extending on both sides thereof.

11. The tray as in claim 1, which is suitable to be used in a microwave oven.
